(19) United States
(12) Patent Application Publication
(10) Pub. No.: US 2026/0292941 A1
(43) Pub. Date: Sep. 24, 2026

(54) HEATING WIRE CONFIGURATION FOR IMAGING SYSTEMS

(71) Applicant: NVIDIA Corporation, Santa Clara, CA (US)

(72) Inventor: Yuval SHAPIRA, Sunnyvale, CA (US)

(73) Assignee: NVIDIA Corporation, Santa Clara, CA (US)

(21) Appl. No.: 19/084,577

(22) Filed: Mar. 19, 2025

(51) Int. Cl. H05B 3/86; H05B 3/26

(52) U.S. Cl. CPC H05B 3/86; H05B 3/265; H05B 2203/003; H05B 2203/031; H05B 2214/02

(57) ABSTRACT

The present disclosure is directed towards heating wire configurations for imaging systems. The heating wire configurations can include a periodic sequence of quarter-circle arcs. The radius of the quarter-circle arcs can be determined at least partially using a coherence length of an optical wavelength of a light emitted by a light source. The light can be interacting with the quarter-circle arcs.

### BACKGROUND

Imaging systems may include linear (e.g., straight, horizontal, vertical) heating wires in a field of view of a camera to mitigate obstruction from, for example, ice or frost, and maintain visibility of the camera. However, the linear heating wires may cause diffraction patterns (e.g., fringe structures) from light sources, such as traffic lights, street lights, brake lights, and/or oncoming headlights. The interference of the heating wire with the optical path of the camera may cause the camera to capture the fringe structures which may lead to misdetection of traffic lights by, for example, autonomous or semi-autonomous vehicles, robots, and/or other machine systems. Conventional solutions, such as a film or mesh, are complex and more expensive to implement, and include their own drawbacks-such as decreased visibility.

### SUMMARY

Implementations of the present disclosure relate to at least one heating wire configuration for imaging systems. Heating wire configurations are disclosed that mitigate fringe structures produced by light sources by spreading the light received from the light sources by the heating wire across, e.g., 360 degrees. The heating wire configuration can include a wire with a radius of curvature (e.g., radius) greater than a coherence length of the light emitted by the light source (e.g., traffic light), and a signal to noise ratio (SNR) can be reduced compared to conventional linear heating wire configurations.

In contrast to conventional systems, the present disclosure includes a wire including a plurality of circular arcs, where each circular arc may include a quadrantal arc. In some embodiments, each of the circular arcs has a radius determined at least partially using a coherence length of an optical wavelength of a light emitted by a light source, where the light is interacting with the circular arcs.

In some implementations, the radius of each of the circular arcs is equal to or greater than 10 times the coherence length. Each of the circular arcs can have a same radius, and the circular arcs can have a same shape. The circular arcs can include a first circular arc and a second circular arc, the second circular arc extending from a first end of the first circular arc. The circular arcs can include a third circular arc, the first circular arc and the second circular arc facing a first direction and the third circular arc facing a second direction opposite the first direction. An imaging system can include a camera, and the wire can be located in a field of view of the camera. The wire can be a plurality of wires, the plurality of wires located in the field of view of the camera. The imaging system can also include a transparent medium in the field of view of the camera, where the wire is embedded in the transparent medium. A machine can include at least one window, an imaging system, and the wire. The machine can provide the wire with an electrical current, the at least one window may be at least partially in a field of view of the imaging system, and the wire may be embedded in the at least one window. The wire can be a plurality of wires and the at least one window is a windshield, the imaging system located within the machine and facing the windshield, the plurality of wires embedded in the windshield in the field of view of the imaging system.

A wire can include a plurality of circular portions including at least a first circular portion and a second circular portion. The second circular portion extends from a first end of the first circular portion, the first circular portion faces a first direction and the second circular portion faces a second direction opposite the first direction, and the plurality of circular portions have a radius determined at least partially using a coherence length of an optical wavelength of a light emitted by a light source, where the light is interacting with the circular portions.

In some implementations, each of the circular portions have a same radius, and the circular portions have a same shape. The first circular portion and the second circular portion can be semicircular arcs. The radius of each of the circular portions can be equal to or greater than 10 times the coherence length. A machine can include at least one window, at least one camera, and the wire where the machine provides the wire with an electrical current, the at least one window is at least partially in a field of view of the at least one camera, and the wire is embedded in the at least one window. A camera housing can be in contact with a portion of the at least one window, the at least one camera located in the camera housing, the plurality of wires embedded in the portion of the at least one window.

A wire can include a plurality of circular portions, where each of the circular portions has a radius determined at least partially using a coherence length of an optical wavelength of a light emitted by a light source, where the light is interacting with the circular portions.

In some implementations, the plurality of circular portions oscillate above and below a center axis. The radius of each of the circular portions can be equal to or greater than 10 times the coherence length. An imaging system can include at least one camera and a transparent medium in a field of view of the at least one camera. The wire can be embedded in the transparent medium.

### BRIEF DESCRIPTION OF THE DRAWINGS

The present systems and methods for heating wire configurations for imaging systems are described in detail below with reference to the attached drawing figures, wherein:

FIG. 1 is an example heating wire configuration, in accordance with some implementations of the present disclosure;

FIG. 2 is an example system of an example heating wire configuration, in accordance with some implementations of the present disclosure;

FIG. 3 is examples of different diffraction cases of heating wire configurations, in accordance with some implementations of the present disclosure;

FIG. 4 is a graph of energy spread of the heating wire configuration of FIG. 1, in accordance with some implementations of the present disclosure;

FIG. 5 is a graph comparing wire density between a linear heating wire and the heating wire configuration of FIG. 1, in accordance with some implementations of the present disclosure;

FIG. 6A is an example of sensor locations having corresponding fields of view or sensory fields for example autonomous or semi-autonomous machines, in accordance with at least some embodiments of the present disclosure;

FIG. 6B is an illustration of an example of component and sensor locations on an autonomous or semi-autonomous vehicle, in accordance with at least some embodiments of the present disclosure;

FIG. 6C is a block diagram of an example system architecture for an autonomous or semi-autonomous vehicle, robot, and/or other machine type, in accordance with at least some embodiments of the present disclosure;

FIG. 6D is a block diagram of an example architecture of a computing system-such as a system-on-a-chip (SoC)—in accordance with at least some embodiments of the present disclosure; and

FIG. 6E is a system diagram for communication between cloud-based server(s) and an example autonomous or semi-autonomous vehicle, robot, and/or other machine type, in accordance with at least some embodiments of the present disclosure.

### DETAILED DESCRIPTION

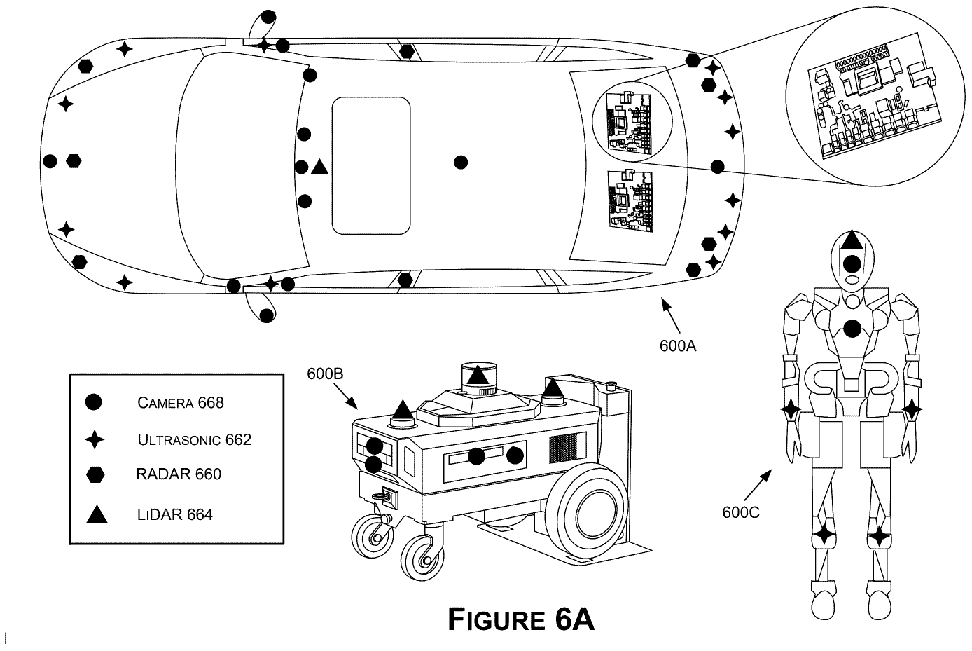

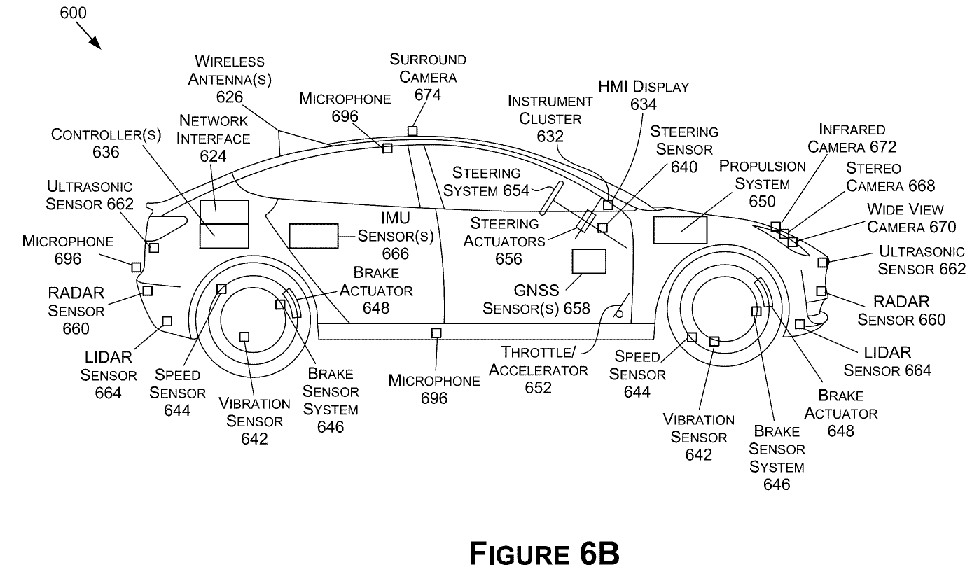

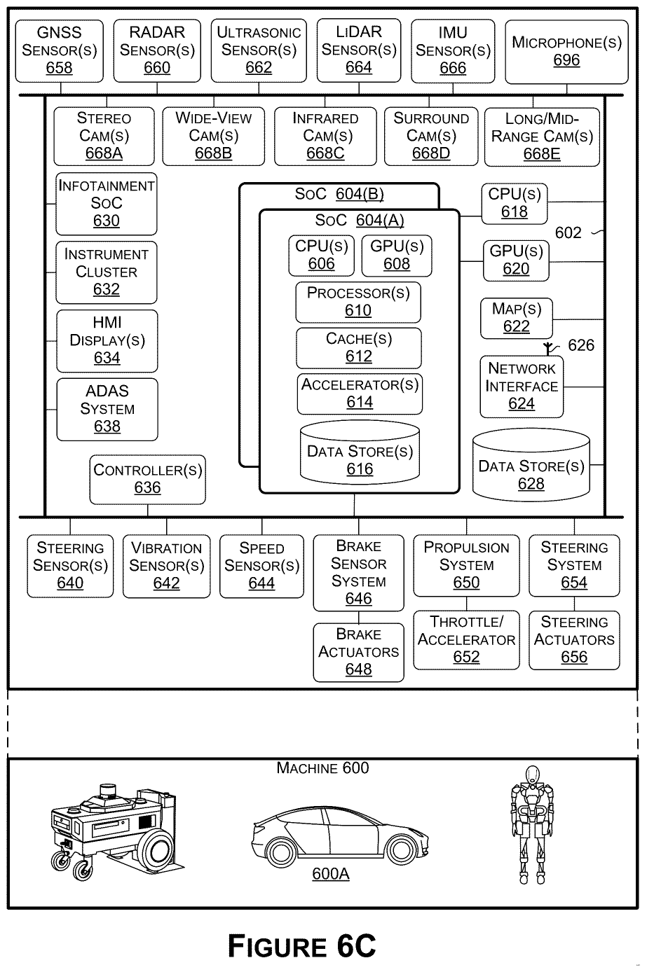

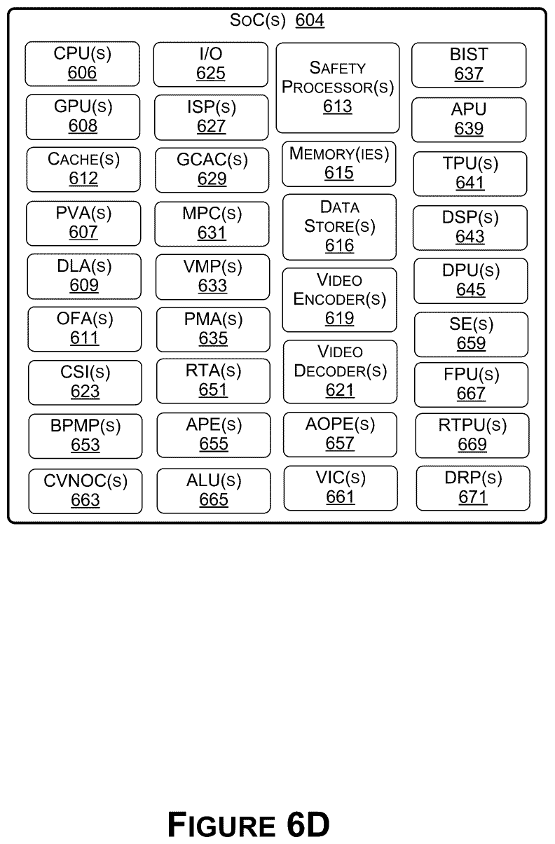

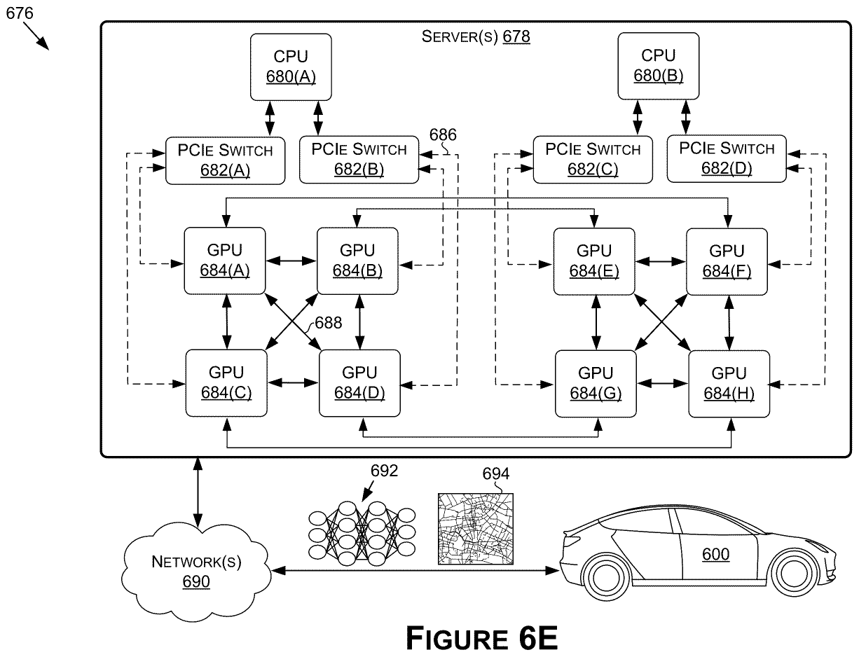

Systems and methods are disclosed related to heating wire configurations for imaging systems. Although the present disclosure may be described with respect to an example autonomous or semi-autonomous vehicle, robot, and/or other machine type 600 (alternatively referred to herein as “vehicle 600,” “ego-vehicle 600,” “machine 600,” “ego-machine 600,” “robot 600,” and/or “ego-robot 600,” an example of which is described with respect to FIGS. 6A-6E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to heating wire configurations embedded in windows (e.g., windshields) of vehicles or sensors, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where heating wires may be used. In some embodiments, the systems, methods, and/or processes described herein may be executed using similar components, features, and/or functionality to those of example machine 600 of FIGS. 6A-6E.

This disclosure relates to systems and methods for a heating wire configuration (e.g., shape, design) to mitigate artifacts (e.g., fringes) in diffraction patterns captured by imaging systems. Heating wires are used alongside imaging systems to maintain visibility, specifically in adverse weather conditions. For example, for a camera behind a front windshield of a vehicle, the vehicle may include heating wires embedded in the front windshield in a field-of-view of the camera to mitigate frost accumulation and maintain visibility of the camera. The fringes captured by the imaging systems, such as interference fringes, may be from light sources with low background light levels (e.g., at night) interacting with the heating wires. In autonomous vehicle applications, the fringes may lead to traffic signal perception errors or detecting and classifying other vehicles as, for example, street lights. Conventional methods, such as straight heating wires spanning along a camera field-of-view, cause imaging systems to capture fringes due to the wires interfering with an optical path of the imaging systems. Other methods to reduce or mitigate the fringes include transparent film or micro meshes which may be costly and complex to implement.

Systems and methods in accordance with the present disclosure include a heating wire configuration to mitigate fringe structures in the diffraction patterns of the light sources. The heating wire configuration may include portions of a circle with a radius determined by a coherence length of the light sources captured by the imaging systems. For example, the heating wire configuration may include a periodic sequence of quarter-circle arcs having a radius greater than the coherence length. Existing methods cause energy to be concentrated along a thin, horizontal wire which cause the imaging systems to capture the fringe structure. On the other hand, the heating wire configuration of the present disclosure enables the energy to be spread around, e.g., 360° degrees of a source image (e.g., image of the light source). The diffraction effect is thus added from the periodic sequence of quarter-circle arcs, and form a circular diffraction pattern, mitigating the fringe structures present in existing methods causing perception errors. The heating wire configuration also improves a signal to noise ratio of the diffraction pattern.

For example, given a coherence length of 0.7 millimeters (mm), the radius of the portions of the circle may be greater than or equal to 7 mm. The radius of the portions of the circle being greater than the coherence length mitigates the fringe structures in the diffraction pattern, and the diffraction pattern may be incoherently added over each portion of the circle. The resulting diffraction pattern of the heating wire configuration may be circular and extend from the light source (e.g., surround the light source).

The systems and methods in accordance with the present disclosure may be applied to and/or integrated into camera housing, lenses, or material (e.g., glass) in front of a camera and/or imaging system. For example, the systems and methods may be applied to surveillance and security cameras (e.g., in a smart cities application, a parking garage application, etc.), automotive (e.g., vehicle cameras), robotics systems (e.g., humanoid robots, autonomous mobile robots, robotic arms or end-effectors, etc.), monitoring systems, aircraft and drone cameras, underwater cameras, and other imaging systems exposed to adverse environments, such as cold or humid conditions causing frost or condensation buildup. As a specific example, the systems and methods of the present disclosure may be integrated with aircraft cameras to mitigate fringe structure diffraction patterns, frost, and condensation which may negatively impact visibility and functionality of the aircraft cameras.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. The sensors may include the heating wire embedded in the sensor, or in a transparent medium that the sensor is facing. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, perception, augmented reality, virtual reality, mixed reality, robotics, security and surveillance, autonomous or semi-autonomous machine applications, and/or any other suitable applications.

Disclosed embodiments may be comprised in a variety of different systems such as automotive systems (e.g., a perception system for an autonomous or semi-autonomous machine, etc.), systems implemented using a robot, aerial systems, medial systems, boating systems, smart area monitoring systems, systems implemented using an edge device, and/or other types of systems.

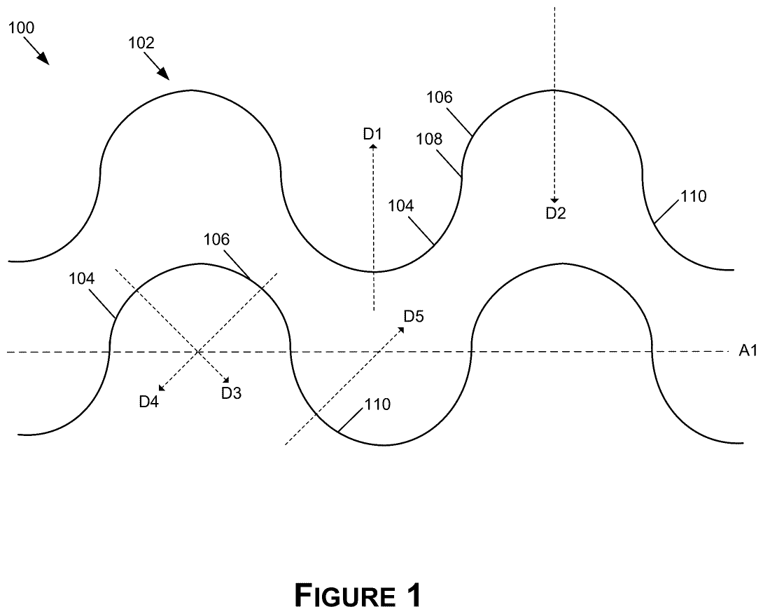

With reference to FIG. 1, FIG. 1 is an example heating wire configuration, in accordance with some in accordance with some implementations of the present disclosure. It should be understood that this and other arrangements described herein are set forth only as examples. Other arrangements, components, features, and elements (e.g., configurations, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., in a sensor). Various functions described herein as being performed by entities may be carried out by hardware, firmware, and/or software. For instance, various functions may be carried out using one or more processors (e.g., microprocessors, microcontrollers, embedded processors, digital signal processors (DSPs), image signal processors (ISPs), etc.) executing instructions stored in memory. In some embodiments, the systems, methods, and processes described herein may be executed using similar components, features, and/or functionality to those of example machine 600 of FIGS. 6A-6E.

FIG. 1 depicts a schematic of an example heating wire configuration 100 (e.g., shape, structure, form). The heating wire configuration 100 is herein referred to as wire 100. The wire 100 includes a plurality of circular portions 102 (e.g., circular arcs, circular segments, portions, curves, arches). The plurality of circular portions 102 are continuous (e.g., contiguous with each other). For example, the wire 100 includes a first circular portion 104 and a second circular portion 106. The first circular portion 104 includes a first end 108 from which the second circular portion 106 extends from. The wire 100 includes a continuous plurality of circular portions 102 that form a wave (e.g., wave shape, wave-like shape).

The plurality of circular portions 102 oscillate above and below a center axis A1. Each crest (e.g., maximum distance above the center axis A1) and trough (e.g., maximum distance below the center axis A1) is formed by an arc of a semicircle (e.g., half circle). The circular portions 102 have a consistent (e.g., equal, same) amplitude along a length of the wire 100. In various implementations, the circular portions 102 have a differing (e.g., different) amplitude along the length of the wire 100. For example, the circular portions 102 have different radiuses. The radius of the circular portions 102 determines (e.g., defines) the amplitude. A wavelength of the plurality of circular portions 102 is the same (e.g., equal) along a length of the wire 100. The wavelength is equal to twice a radius (e.g., a diameter) of the circular portions 102. For example, the circular portions 102 have the same radius. Each of the circular portions 102 has a same shape, such as a semicircular arc. The wire 100 has a continuous, smooth shape, as well as a continuous derivative (e.g., equal or same derivative along the length).

As shown in FIG. 1, the first circular portion 104 and the second circular portion 106 can be semicircular arcs (e.g., arcs, segments, semicircles). The semicircular arcs have a central angle of 180 degrees, and spans one half of a circle. The second circular portion 106 extends from the first circular portion 104, and the first circular portion 104 faces (e.g., is angled towards, oriented towards) a first direction D1, and the second circular portion 106 faces a second direction D2. The second direction D2 is opposite the first direction D1. As such, the first circular portion 104 can also be described as having a positive concavity (e.g., concave up), and the second circular portion 106 has a negative concavity (e.g., concave down). The plurality of circular portions 102 can also include a third circular portion 110 extending from the second circular portion 106. The third circular portion 110 may face the first direction D1. The wire 100 may also be described as having concatenated semicircular arcs.

In some implementations, the plurality of circular portions 102 are a plurality of circular arcs (e.g., segments, curves), and each of the circular arcs is a quadrantal arc (e.g., quarter arc, quarter-circle segment, quadrant arc, quadrantal circular portion). The quadrantal arc has a central angle of 90 degrees, and an arc length (e.g., length) equal to a fourth of a circumference of a circle. In this case, the first circular portion 104 and the second circular portion 106 are quadrantal arcs, and form a semicircular arc. For example, the second circular portion 106 extends from the first circular portion 104, forms a semicircle, and the formed semicircle faces the first direction D1. The third circular portion 110 is continuous with and extends from the second circular portion 106. The third circular portion 110 is also a quadrantal arc, and is angled such that if the third circular portion 110 forms a semicircle (e.g., with a fourth circular portion), the semicircle faces the second direction D2. The first circular portion 104 and the second circular portion 106 may have the same concavity (e.g., positive or negative), and the third circular portion 110 has a concavity opposite the first circular portion 104 and the second circular portion 106.

In cases where the plurality of circular portions 102 are quadrantal arcs, and the first circular portion 104 and the second circular portion 106 form a semicircle, tangent lines at midpoints (e.g., center) of the first circular portion 104 and the second circular portion 106 intersect and form a 90 degree angle. Tangent lines at midpoints of the second circular portion 106 and the third circular portion 110 do not intersect, and are parallel to each other. Normal lines at the midpoints of the first circular portion 104 and the second circular portion 106 intersect with the center axis A1, and form a 90 degree angle with each other. Both the normal lines and the tangent lines of the first circular portion 104 and the third circular portion 110 may intersect and form 90 degree angles. The first circular portion 104, the second circular portion 106, and the third circular portion 110 face respective directions extending from an intersection of the tangent line at the midpoint and the normal line, to an intersection of the normal line and the center axis A1. For example, the first circular portion 104 faces a third direction D3, the second circular portion 106 faces a fourth direction D4 orthogonal to the third direction D3, and the third circular portion 110 faces a fifth direction D5, parallel to the fourth direction D4. The wire 100 is formed of a continuous, connecting plurality of circular portions 102 where each of the plurality of circular portions 102 is rotated and translated relative to adjacent circular portions 102 such that the wire 100 is a periodic waveform of sequentially connected series of quadrantal arcs.

Each of the circular portions 102 have the same radius, and the radius is determined at least partially using a coherence length of an optical wavelength of a light (e.g., distance at which wavelength maintains coherence) emitted by a light source. In some implementations, the circular portions 102 having different radiuses while maintaining an equal angular distribution (e.g., equal angles of tangents, 90 degrees between normal lines). The light emitted by the light source interacts (e.g., engages) with the wire 100. For example, the light is emitted onto a surface which the wire 100 is embedded (e.g., engraved) into. The light source can be a device, apparatus, or system that emits light. For example, in a vehicle driving context, the light source may be a traffic light, a pedestrian cross walk light, vehicle headlights, a street lamp, construction lights, etc. The radius can thus be determined by both a geometry of the light source, and a distance the wire 100 is from the light source.

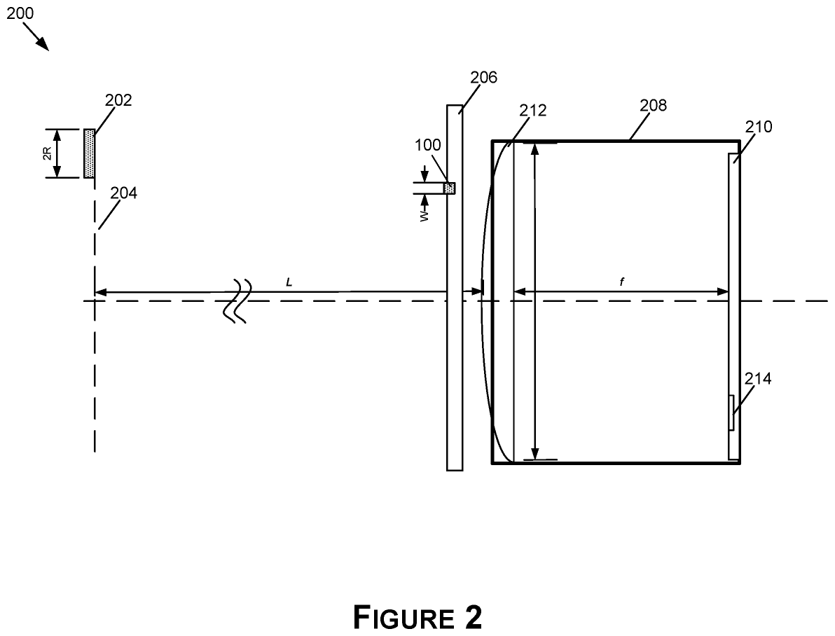

FIG. 2 is an example system 200 of a light source 202 emitting light interacting with the wire 100. The light source 202 may be, for example but not limited to, a traffic light. The light source 202 is located on (e.g., extends along) a light source plane 204. In the system 200, the wire 100 can be imprinted (e.g., embedded) into a medium 206 (e.g., transparent medium), such as a windshield of a vehicle or a cover screen of a sensor (e.g., light detection and ranging (LiDAR)). The light is emitted at an optical wavelength. The optical wavelength may be in the visible light, infrared (IR), or ultraviolet (UV) spectrum. The wire 100 can be defined at least by a width w. The system 200 also includes a camera 208 (e.g., image capture device, imaging system). The light source plane 204 is a distance L away from the camera 208. The camera 208 captures images. For example, the camera 208 may be mounted to a vehicle and face a windshield of the vehicle, and capture and record images of an environment of the vehicle. The medium 206 can be located between the light source 202 and the camera 208 such that the wire 100 is in the field of view of the camera.

The camera 208 can include a sensor 210 (e.g. image processor) and a lens 212. The sensor 210 can convert light into an electrical signal to form a digital image. The lens 212 is located between the medium 206 and the sensor 210, and focuses light from the medium 206 onto the sensor 210. The sensor 210 can be located a distance f away from the lens 212 within the camera 208. The camera 208 is located on an opposite side of the wire 100 from the light source 202. The camera 208 may capture at least one of visible length, infrared, or UV light. The wire 100 is located in a field of view (e.g., vision, scope, purview, visual range) of the camera 208. The camera 208 can capture at least one light source image 214 of the light source 202. The light source image 214 can be taken by the camera 208 with the wire 100 in the field of view of the camera 208. In some implementations, the camera 208 is at least one of a sensor, such as a LiDAR. In such cases, the wire 100 can be embedded into the lens 212 of the camera 208. The wire 100 can be embedded into any sensor operating on optical wavelengths such as a sensor exposed to outdoor conditions (e.g., a sensor coupled to an outside of a vehicle, LiDAR).

For example, assuming a source distribution of l(Δx, Δy) for the light source 202, the spatial coherence function of the light source 202 at distance L is given by:

$$Γ ( Δ x , Δ y ) = F \{ I \} {\vert}_{\frac{Δ x}{λ L} , \frac{Δ y}{λ L}} . \qquad ( 1 )$$

The light source 202 can be modeled by:

$$I ( Δ x , Δ y ) = exp ( - π \frac{Δ {x}^{2} + Δ {y}^{2}}{{R}^{2}} ) . \qquad ( 2 )$$

The coherence function can thus be provided by:

$$Γ ( Δ x , Δ y ) = exp ( - π {R}^{2} ( Δ {x}^{2} + Δ {y}^{2} ) ) {\vert}_{\frac{Δ x}{λ L} , \frac{Δ y}{λ L}} = exp ( - {π ( \frac{R}{λ L} )}^{2} ( Δ {x}^{2} + Δ {y}^{2} ) ) . \qquad ( 3 )$$

As an example, given a light source 202 with a diameter of 0.2 meters (m) (e.g., radius of 0.1 m) at a distance of 100 m from the wire 100, the coherence distance is:

$$2 \frac{λ L}{R} = 0.5 {e}^{- 6} \times \frac{100}{0.1} = 1 millimeter ( mm ) .$$

As shown above, the coherence distance can be equal to a coherence length which can be a function of a size of the light source 202, distance of the light source 202 from the wire 100, and the wavelength of the light source 202. The coherence length of the optical wavelength of the light emitted by the light source 202 may be about 1 mm. A wire width of the wire 100 can be in a range between 0.5 to 1 mm, inclusive.

An aperture function of the camera 208 may be defined by:

$$\hat{f} ( {k}_{x} ) = \begin{matrix}f ( x ) \\ FourierTransform ( f ( x ) )\end{matrix} . \qquad ( 4 )$$

In a case that the light emitted by the light source 202 is coherent, the coherence may follow:

$${u}_{out} ( x ) = {u}_{in} ( x ) * \hat{f} ( \frac{x}{λ f} ) . \qquad ( 5 )$$

In a case that the light emitted by the light source 202 is incoherent, the incoherence may follow:

$${‖ {u}_{out} ‖}^{2} = {‖ {u}_{in} ‖}^{2} * {‖ \hat{f} ( \frac{x}{λ f} ) ‖}^{2} . \qquad ( 6 )$$

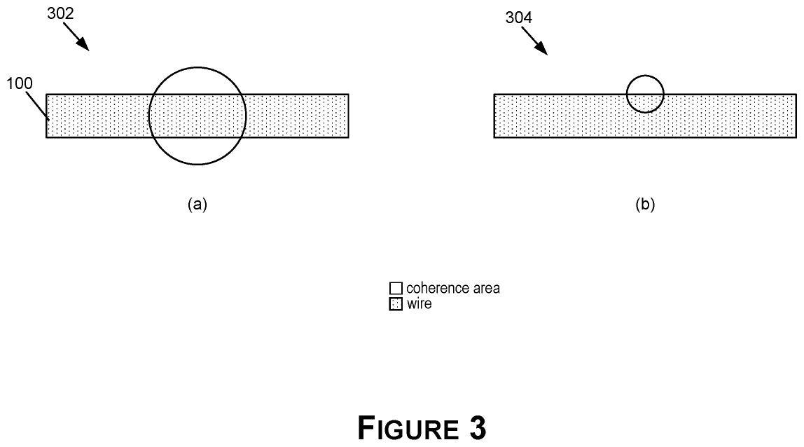

FIG. 3 depicts a first diagram 302 where a coherence length of the light source 202 is greater than the width of the wire 100, and a second diagram 304 where the coherence length of the light source 202 is less than the width of the wire 100. A circle on the first diagram 302 and the second diagram 304 indicates a coherence area while a rectangle indicates the wire 100. The situation (e.g., scenario) of the first diagram 302 can be described by:

$$f ( x ) = rect ( \frac{x}{W} ) and \qquad ( 7 )$$

$$\hat{f} ( \frac{x}{λ f} ) = sync ( \frac{xW}{λ f} ) . \qquad ( 8 )$$

The situation of the first diagram 302 (e.g., the coherence length being greater than the width of the wire 100), indicates that the camera 208 captures fringes (e.g., artefacts, fringe patterns, fringe structures) from the light source 202. The situation of the second diagram 304 can be described by:

$$f ( x ) = step ( x ) and \qquad ( 9 )$$

$$\hat{f} ( \frac{x}{λ f} ) = \frac{λ f}{jx} . \qquad ( 10 )$$

The situation of the second diagram 304 (e.g., the coherence length less than the width of the wire 100), indicates that the camera 208 does not capture fringes from the light source 202. Fringes may appear on images captured by the camera 208 responsive to a radius of the light source 202 being smaller than, for example, 0.1 m, or the light source 202 being further away (e.g., such that the coherence area is larger than the width of the wire 100). The coherence area is proportional to distance of the light source 202 from the sensor 210 and inversely proportional to size of the light source 202. Referring back to FIG. 2, the distance between the light source 202 and the sensor 210 can be a summation of a thickness of the medium 206, L, and f. For example, the camera 208 captures fringes in response to the coherence length being greater than the width of the wire 100.

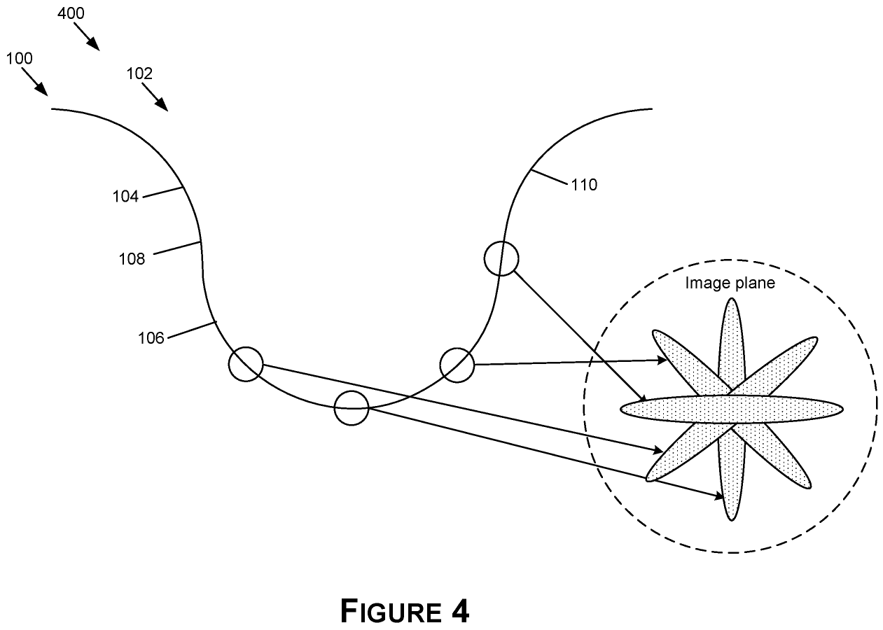

FIG. 4 is a graph 400 of the wire 100 illustrating a coherence area along the wire 100. The wire 100 spreads energy (e.g., light) across 360 degree angles around a source image (e.g., captured by the camera 208). Compared to a linear wire, a SNR of a diffraction pattern created by the wire 100 is diminished by 2 orders of magnitude or more. The diffraction effect (e.g., pattern) of the wire 100 is incoherently added from multiple quasi-linear pieces (e.g., circular portions 102) along the length of the wire 100. As such, the wire 100 does not produce fringes resulting from a coherent interference from the wire 100, and the diffraction effect captured has a circular shape extending around the light source 202, thereby improving the SNR. For example, the wire 100 produces fringes originating from an interference between different portions of the wire 100, as shown in FIG. 4. The wire 100 spreads the light into uniform directions to produce the circular shape of the diffraction effect. For example, the wire 100 may produce an Airy disk diffraction pattern. Consequently, the light source image 214 can include the Airy disk diffraction pattern extending from the light source 202 in the light source image 214. For the wire 100 to spread the light into uniform directions, the coherence length is less than a radius of curvature (e.g., radius) of the wire 100 such that:
r>>W (11) where W is coherence length.

In some implementations, the radius of the wire 100 is greater than or equal to ten times the coherence length. For example, for a coherence length of 1 mm, the radius of the wire 100 is greater than or equal to 7 mm. The radius of the wire 100 can also be referred to as an amplitude of the wire 100.

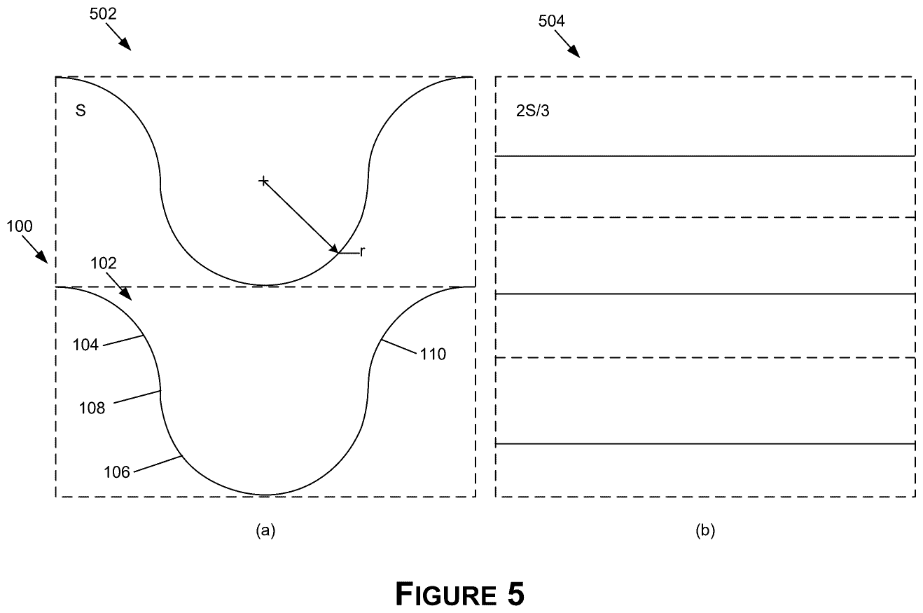

FIG. 5 illustrates a first chart 502 of the wire 100, and a second chart 504 of a linear wire. In some implementations, the wire 100 is located in the field of view of the camera 208. The camera 208 may be included in an imaging system, and the imaging system may include a transparent medium (e.g., glass, medium 206) in the field of view of the camera 208. The wire 100 may be embedded in the transparent medium, and the wire 100 may include a plurality of wires 100 embedded in the transparent medium and in the field of view of the camera 208. In some implementations, the wire 100 is a heating wire (e.g., heated wire). For example, the wire 100 is provided with an electric current such that it produces heat while embedded in the transparent medium. The electric current can be provided by, for example, a battery of a vehicle. The wire 100 can thus mitigate frost, condensation, etc. build up on the transparent medium, and maintain visibility for the camera 208.

The first chart 502 and the second chart 504 illustrate a wire density (e.g., total area of wire over heating area). The wire 100 of the first chart 502 has an equal wire density to a linear, conventional wire of the second chart 504. The wire density in the first chart 502 may be 2πrW/S~6rW/S while the wire density in the second chart 504 may be 4rW/(2S/3)=6rW/S. As shown in the first chart 502 and the second chart 504, the wire 100 may be π/2 times (e.g., about 3/2) longer than a linear wire. Therefore, the wire 100 and the linear wire can have similar wire density and thereby similar heating capability per area of, for example, the lens 205.

For example, the wire 100 is embedded in at least one window (e.g., windshield, medium 206) of a vehicle (e.g., vehicle 600). The vehicle includes at least one camera (e.g., the camera 208). The vehicle provides the wire 100 with an electrical current such that the wire 100 produces heat. The window is at least partially in the field of view of the camera 208 such that the wire 100 embedded in the window is in the field of view of the camera 208. In some implementations, the wire 100 is embedded in the lens 212. In some implementations, the camera 208 is located within the vehicle and facing the window, and the wire 100 is a plurality of wires 100. The plurality of wires 100 is embedded in a portion of the window in the field of view of the camera 208. The camera 208 may be located in a camera housing, and the camera housing can be in contact with the windshield while the camera 208 is located a distance behind (e.g., away from) the windshield. For example, the camera 208 is located a distance f from the windshield within the camera housing. The camera housing can be mounted (e.g., coupled) to a roof and the windshield of the vehicle. The camera housing may be in contact with a portion of the windshield such that the camera housing limits the field of view of the camera 208 to the portion of the windshield within the camera housing. The wire 100 (e.g., the plurality of wires 100) is embedded in the portion of the windshield within the camera housing.

As another example, the wire 100 may be coupled to, associated with, or embedded with a sensor or camera to maintain functionality. For example, the wire 100 may maintain a temperature of the sensor, and may mitigate reduced visibility due to adverse weather conditions, such as rain, frost, or snow. The wire 100 may mitigate condensation build up and maintain a temperature of the camera.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, perception, augmented reality, virtual reality, mixed reality, robotics, security and surveillance, autonomous or semi-autonomous machine applications, and/or any other suitable applications.

Disclosed embodiments may be comprised in a variety of different systems such as automotive systems (e.g., a perception system for an autonomous or semi-autonomous machine, etc.), systems implemented using a robot, aerial systems, medial systems, boating systems, smart area monitoring systems, systems implemented using an edge device, and/or other types of systems.

### Example Autonomous or Semi-Autonomous Machine

FIG. 6A is an example of sensor locations having corresponding fields of view or sensory fields for an autonomous or semi-autonomous vehicle 600a, an autonomous mobile robot (AMR) 600b, and a humanoid robot 600c, in accordance with some embodiments of the present disclosure. Although three types of machines 600 are illustrated, this is not intended to be limiting, and the machine(s) 600 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 600a, AMR 600b, humanoid robot 600c, and/or other machine types may be referred to herein collectively as machine 600, in some instances.

With respect to vehicles 600A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 600 may be capable of functionality in accordance with one or more of Level 3-Level 5 of the autonomous driving levels. The machine 600 may be capable of functionality in accordance with one or more of Level 1-Level 5 of the autonomous driving levels. For example, the machine 600 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 600 or other machine, such as being fully autonomous, being highly autonomous, being conditionally autonomous, being partially autonomous, providing assistive autonomy, being semi-autonomous, being primarily autonomous, or other designation.

With respect to FIG. 6A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 668D, a 180 degree field of view of a wide-view camera 670, a 360 degree sensory field of a LiDAR sensor 664, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 600a, AMR 600b, and/or humanoid robot 600c, etc. For example, with respect to the vehicle 600a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 600b and/or humanoid robot 600c, the shape, size, purpose, implementation, model, etc. may dictate the number and types of sensors used.

As illustrated in FIG. 1A, the autonomous or semi-autonomous vehicle 600A, the AMR 600B, and the humanoid robot 600C may include different sensor types, number, and locations. For a non-limiting example, the vehicle 600A may include twelve cameras 664, such as a front wide camera (e.g., 120 degree field of view (FOV)), a front telephoto camera (e.g., 30 degree fOV), a side rear left camera (e.g., 70 degree fOV), a side rear right camera (e.g., 70 degree fOV), a front fisheye camera (e.g., 200 degree fOV), a rear fisheye camera (e.g., 200 degree fOV), a left fisheye camera (e.g., 200 degree fOV), a right fisheye camera (e.g., 200 degree fOV), a front telephoto satellite camera (e.g., 30 degree fOV), a rear telephoto camera (e.g., 30 degree fOV), a cross left camera (e.g., 120 degree fOV), and a cross right camera (e.g., 120 degree fOV). The camera(s) 664 may use, in embodiments, a gigabit multimedia serial link (GMSL) interface-such as GMSL2—as input/output (I/O).

In some embodiments, although not illustrated in FIG. 6A, the vehicle 600A may include an in-cabin occupant and/or driver monitoring system, that may include various different sensors. For example, the in-cabin sensors may include various cameras 668, such as a driver monitoring camera (e.g., 55 degree fOV positioned forward of and facing toward the driver seat), a front occupant monitoring camera (e.g., 190 degree fOV positioned forward of and facing the front occupant(s) seat(s)), and a rear occupant monitoring camera (e.g., 190 degrees positioned forward of and facing the rear occupant(s) seat(s)). Similar to the external facing camera(s) 668, the internal camera(s) 668 may, in embodiments, use a GMSL (such as GMSL2) interface for I/O.

As another non-limiting example, the vehicle 600A may further include nine RADAR sensors 660. For example, the vehicle 600A may include a front center imaging RADAR sensor (e.g., 120 degree fOV or sensory field), a corner front left RADAR sensor (e.g., 160 degree fOV or sensory field), a corner front right RADAR sensor (e.g., 160 degree fOV or sensory field), a corner rear right RADAR sensor (e.g., 160 degree fOV or sensory field), a side left RADAR sensor (e.g., 160 degree fOV or sensory field), a side right RADAR sensor (e.g., 160 degree fOV or sensory field), a rear left RADAR sensor (e.g., 50 degree fOV or sensory field), and rear right RADAR sensor (e.g., 50 degree fOV or sensory field). The RADAR sensor(s) 660 may use, in embodiments, an Ethernet interface as I/O.

The vehicle(s) 600A may further include, as a non-limiting example, twelve ultrasonic sensors 662. As illustrated in FIG. 6A, the ultrasonic sensors may be positioned along the front and rear bumpers of the vehicle 600A, and along the side of the vehicle 600A, and may be used to detect objects (static and dynamic) in close proximity to the vehicle 600A. In some embodiments, the ultrasonic sensor(s) 662 may use a DS13 interface as I/O.

The vehicle(s) 600A may further include, as a non-limiting example, a LiDAR sensor 664, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 664 may include a 360 degree horizontal FOV or sensory field (such as in a spinning LiDAR sensor) and a 90 degree vertical FOV or sensory field. In some embodiment, the LiDAR sensor(s) 664 may use an Ethernet interface as I/O.

The autonomous mobile robot (AMR) 600B may include, as a non-limiting example, three LiDAR sensors 664. For example, the top-most illustrated LiDAR sensor 664 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 600B may further include, as a non-limiting embodiment, eight cameras 668, such as a front stereo camera (e.g., 120 degree fOV), a rear stereo camera (e.g., 120 degree FOV), a left stereo camera (e.g., 120 degree fOV), a right stereo camera (e.g., 120 degree fOV), a front fisheye camera (e.g., 202 degree+−3 degree fOV), a rear fisheye camera (e.g., 202 degree+−3 degree fOV), a left fisheye camera (e.g., 202 degree+−3 degree fOV), and a right fisheye camera (e.g., 202 degree+−3 degree fOV).

The AMR 600B may further include a charging port, charging port contacts, a status indicator light, one or more (e.g., four) RGB LEDs, one or more IMU sensors 666, a magnetometer, and a barometer. The AMR 600B is capable of high-precision time synchronization between sensors using hardware time stamping, and PTP over Ethernet with less than 10 microseconds for sensor acquisition time. The AMR 600B provides simultaneous camera capture across all cameras 668 within 100 microseconds from a single hardware trigger, in embodiments, and can write to disk at 4 GB/second for sensor capture to bag writing (e.g., writing to ROSbags for the robot operation system (ROS)). As such, the AMR 600B is capable of running the ROS (such as NVIDIA's Isaac ROS), can be teleoperated (as described herein), can map an environment, and can navigate within an environment using visual cameras 668, LiDARs 664, and/or other sensor types or modalities.

The humanoid robot 600C may include, as a non-limiting example, one LiDAR sensor 664. For example, the LiDAR sensor 664 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 600C may further include, as a non-limiting embodiment, four cameras 668, such as a front stereo camera (e.g., 120 degree fOV), a rear stereo camera (e.g., 120 degree fOV), a front fisheye camera (e.g., 202 degree+−3 degree fOV), and a rear fisheye camera (e.g., 202 degree+−3 degree fOV).

The humanoid robot 600C may further include, as a non-limiting embodiment, four ultrasonic sensors 662, such as a left arm ultrasonic sensor, a right arm ultrasonic sensor, a left leg ultrasonic sensor, and right leg ultrasonic sensor.

The humanoid robot 600C may further include any number of actuators-such as to allow control and maneuverability of joints. For example, the humanoid robot 600C may include actuators that allow for various degrees of freedom (DoF) depending on the design. In a non-limiting embodiment, the humanoid robot 600C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 600C may include position and orientation sensors, such as encoders, gyroscopes, and the like, to determine the position of the robot 600C in space, allowing for location determination and movement tracking. The humanoid robot 600C may include force and pressure sensors, in embodiments, to detect environment interactions, allowing the robot 600C to grasp objects with the right force and to avoid obstacles along the way. The perception sensors (e.g., cameras, LiDARs, RADARs, ultrasonic, SONAR, etc.) may be used along with tactile sensors to allow the robot 600C to perceive objects, shapes, and textures, and to understand when touch is initiated and stopped (along with force sensors that regulate the force used during touch). As a non-limiting example, the humanoid robot 600C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 600C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 600C may use onboard sensors, microphones, and speakers to understanding speech, audio and visual cues, etc., while also being able to communicate back to the environment.

With reference to cameras 668 of the machine(s) 600, the camera types for the cameras 668 may include, but are not limited to, digital cameras that may be adapted for use with the components and/or systems of the machine 600. For a vehicle 600a implementation, the camera(s) 668 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 600 (e.g., front-facing cameras) may be used for surround view, to help identify forward facing paths and obstacles, as well aid in, with the help of one or more controllers 636 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 668B that may be used to perceive objects coming into view from the periphery (e.g., pedestrians, warehouse vehicles, other robots, crossing traffic, or bicycles). In addition, any number of long-range camera(s) 668E (e.g., a long-view stereo camera pair) may be used for depth-based object detection, especially for objects for which a neural network has not yet been trained. The long-range camera(s) 668E may also be used for object detection and classification, as well as basic object tracking.

Any number of stereo cameras 668A may also be included in a front-facing and/or other (e.g., rear-facing) configuration. In at least one embodiment, one or more of stereo camera(s) 668A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 600 environment, including a distance estimate for points in the image (e.g., a disparity or depth image). An alternative stereo camera(s) 668A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 600 (e.g., side-view cameras) may be used, for example, for surround view, providing information used to create and update the occupancy grid, as well as to generate side impact collision warnings and/or to indicate to an AMR 600B or humanoid robot 600C, for example, that there are objects, features, and/or persons present to the side. For example, surround camera(s) 668D may be positioned on the machine 600. The surround camera(s) 668D may include wide-view camera(s) 668B, fisheye camera(s), 360 degree camera(s), and/or the like. For example, four fisheye cameras may be positioned on the machine's 600 front, rear, and sides. In an alternative arrangement, the machine 600 may use three surround camera(s) 668D (e.g., left, right, and rear), and may leverage one or more other camera(s) (e.g., a forward-facing camera) as a fourth surround view camera.

Cameras 668 with a field of view that include portions of the environment to the rear of the machine 600 (e.g., rear-view cameras) may be used for gaining an understanding of objects, features, persons, and/or other information to the rear of the machine 600, such as for park assistance, surround view, rear collision warnings, planning, control, and navigation determinations, and/or creating and updating an occupancy grid, BEV image representing the environment, height map, etc. A wide variety of cameras 668 may be used including, but not limited to, cameras 668 that are also suitable as a front-facing camera(s) (e.g., long-range and/or mid-range camera(s) 668E, stereo camera(s) 668A), infrared camera(s) 668C, etc.), rear-facing camera(s), side-facing camera(s), downward facing camera(s), upward facing camera(s), and/or the like, as described herein.

Similarly, for LiDAR sensors 664, RADAR sensors 660, ultrasonic sensors 662, and/or other sensor modalities or types, the location and placement of the sensors, and their corresponding fields of view or sensory fields may be determined based on the use case, implementation, or design of the particular machine 600.

For example, the machine(s) 600 include RADAR sensor(s) 660 that may be used by the machine 600 for long-range object detection, even in darkness and/or severe weather conditions. RADAR functional safety levels may be ASIL B, in embodiments. The RADAR sensor(s) 660 may use the CAN and/or the bus 602 (e.g., to transmit data generated by the RADAR sensor(s) 660) for control and to access object tracking data, with access to Ethernet to access raw data in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning, by robots for detecting dynamic objects in various environments-such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 600 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 660 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 600 (e.g., vehicle, robot, etc.). As such, short-range RADAR systems may be used in an ADAS system for blind spot detection and/or lane change assist.

The machine 600 may further include ultrasonic sensor(s) 662. The ultrasonic sensor(s) 662, which may be positioned at the front, back, and/or the sides of the machine 600, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 600. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B, as an example.

The machine 600 may include LiDAR sensor(s) 664. The LiDAR sensor(s) 664 may be used for object and feature detection, pedestrian and other robot detection, emergency braking, collision avoidance, simultaneous localization and mapping (SLAM), free-space detection, and/or other functions. The LiDAR sensor(s) 664 may be functional safety level ASIL B, in embodiments. In some examples, the machine 600 may include multiple LiDAR sensors 664 (e.g., two, four, six, etc.) that may use Ethernet (e.g., to provide data to a Gigabit Ethernet switch).

In some examples, the LiDAR sensor(s) 664 may be capable of providing a list of objects and their distances for a 360-degree field of view. Commercially available LiDAR sensor(s) 664 may have an advertised range of approximately 600 m, with an accuracy of 2 cm-3 cm, and with support for a 600 Mbps Ethernet connection, for example. In some examples, one or more non-protruding LiDAR sensors 664 may be used. In such examples, the LiDAR sensor(s) 664 may be implemented as a small device that may be embedded into the front, rear, sides, top, and/or corners of the machine 600. The LiDAR sensor(s) 664, in such examples, may provide up to a 120-degree horizontal and 35-degree vertical field-of-view, with a 200 m range even for low-reflectivity objects. Front-mounted LiDAR sensor(s) 664 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 600. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 664 may be less susceptible to motion blur, vibration, and/or shock.

FIG. 6B is an illustration of sensor and component locations of an example autonomous or semi-autonomous vehicle 600A (alternatively referred to herein as “vehicle 600,” “ego-vehicle 600,” “ego-machine 600,” or “machine 600,”), in accordance with some embodiments of the present disclosure. Although the vehicle 600A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 6C is a block diagram of an example system architecture for a machine 600, such as autonomous or semi-autonomous vehicle 600A, autonomous mobile robot (AMR) 600B, humanoid robot 600C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 600 of FIGS. 6A-6E.

Each of the components, features, and systems of the machine 600 in FIG. 6C are illustrated as being connected via bus 602 (alternatively referred to as a “machine communications network 602,” or just “communications network 602”). The bus 602 may include a Controller Area Network (CAN) data interface (alternatively referred to herein as a “CAN bus”). A CAN may be a network inside the machine 600 used to aid in control of various features and functionality of the machine 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 602 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the machine 600, and two or more busses 602 may communicate with the same components. In some examples, each SoC 604, each controller 636, and/or each computer or compute engine within the machine 600 may have access to the same input data (e.g., inputs from sensors of the machine 600), and may be connected to a common bus, such as a CAN bus.

The machine 600 may include components such as a chassis, a vehicle body, wheels (e.g., 2, 4, 6, 8, 18, etc.), tires, axles, batteries, side-view mirrors, and/or other components of a vehicle or machine. The machine 600 may include a propulsion system 650, such as an internal combustion engine, hybrid electric power plant, an all-electric engine, a hydrogen-fueled engine, and/or another propulsion system type. The propulsion system 650 may be connected to a drive train of the machine 600, which may include a transmission, to enable the propulsion of the machine 600. The propulsion system 650 may be controlled in response to receiving signals from the throttle/accelerator 652.

A steering system 654, which may include a steering wheel and/or other steering device (e.g., remote steering and/or local steering), may be used to steer the machine 600 (e.g., along a desired path or route) when the propulsion system 650 is operating (e.g., when the vehicle is in motion). The steering system 654 may receive signals from a steering actuator 656. In some embodiments, a steering wheel or other steering mechanism may not be included, such as for a machine 600 capable of full automation (e.g., Level 5) functionality.

The brake sensor system 646 may be used to operate the vehicle brakes in response to receiving signals from the brake actuators 648 and/or brake sensors.

The machine 600 may include one or more controller(s) 636, such as those described herein with respect to FIG. 6A. The controller(s) 636 may be used for a variety of functions, and may be coupled to any of the various other components and systems of the machine 600. For example, the controllers 636 may be used for control of the machine 600, artificial intelligence executing on the machine 600, infotainment for the machine 600, and/or the like. For example, one controller 636 may be used for some or all of the functionality, or different controllers 636 may be used for different functionalities—e.g., to ensure availability and a safety separation between various controllers for different tasks. For example, the controller(s) 636 may use plans computed by the system—e.g., paths or trajectories for vehicles 600A or AMRs 600B, or movements, components trajectories, movement locations or displacements, etc. for joints or components (e.g., of manipulators, end effectors, limbs, hands, fingers, legs, feet, etc.), of a humanoid robot 600C—to control the machine(s) 600 in the environment. In some instances, the controller(s) 636 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 600C, for example, the controller(s) 636 may act as the brain, responsible for analyzing sensor data, making decisions, and sending commands to the actuators. The controller(s) 636 may include a low-level controller that handles basic motor control, ensuring accurate and precise movements of individual joints and actuators. The controller(s) 636 may include a high-level controller to coordinate multiple actuators and sensors, planning complex motions and adapting to changing environments.

The controller(s) 636 may include an artificial intelligence controller, in embodiments, that may use AI algorithms (e.g., DNNs, MLMs, etc.) to learn, make decisions, and autonomously perform tasks for the machine 600. In some embodiments, the controller(s) 636 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 636 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 636, which may include one or more systems on chip (SoCs) 604 (FIGS. 6C and 6D), CPUs, GPU(s), accelerator(s), etc., may provide signals (e.g., representative of commands or messages) to one or more components and/or systems of the machine 600. Although the controller(s) 636 is listed separately from the SoC(s) 604, this is not intended to be limiting, and in some embodiments one or more components of the SoC(s) 604 may perform the operations of the controller(s) 636. For example, the controller(s) may send signals to operate the machine brakes via one or more brake actuators 648, to operate the steering system 654 via one or more steering actuators 656, to operate the propulsion system 650 via one or more throttle/accelerators 652, etc. The controller(s) 636 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 600. The controller(s) 636 may include a first controller 636 for autonomous control and navigation functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 636 may handle two or more of the above functionalities, two or more controllers 636 may handle a single functionality, and/or any combination thereof.

The controller(s) 636 may provide the signals for controlling one or more components and/or systems of the machine 600 in response to sensor data received from one or more sensors (e.g., sensor inputs). The sensor data may be received from, for example and without limitation, global navigation satellite systems (“GNSS”) sensor(s) 658 (e.g., Global Positioning System sensor(s)), RADAR sensor(s) 660, ultrasonic sensor(s) 662, LiDAR sensor(s) 664, inertial measurement unit (IMU) sensor(s) 666 (e.g., accelerometer(s), gyroscope(s), magnetic compass(es), magnetometer(s), etc.), microphone(s) 696, camera(s) 668 (e.g., stereo camera(s) 668A, wide-view camera(s) 668B (e.g., fisheye cameras), infrared camera(s) 668C, surround camera(s) 668D (e.g., 360 degree cameras), long-range and/or mid-range camera(s) 668E, and/or other camera types), speed sensor(s) 644 (e.g., for measuring the speed of the machine 600), vibration sensor(s) 642, steering sensor(s) 640, brake sensor(s) (e.g., as part of the brake sensor system 646), actuators, and/or other sensor types.

One or more of the controller(s) 636 may receive inputs (e.g., represented by input data) from an instrument cluster 632 of the machine 600 and provide outputs (e.g., represented by output data, display data, etc.) via a human-machine interface (HMI) display 634 (e.g., screen, heads-up display, mirror display, facial display, robotic display, etc.), an audible annunciator, a loudspeaker, a speaker, and/or via other components of the machine 600. The outputs may include information such as machine velocity, speed, time, map data corresponding to a map(s) 622 of FIG. 6C (e.g., from a navigation map, a Standard Definition (SD) map, a High Definition (“HD”) map, etc.), location data (e.g., the machine's 600 location, such as on a map 622), direction, location of other vehicles (e.g., an occupancy map, height map, bird's eye view (BEV) image, grid, etc.), information about objects and status of objects as perceived by the system, system status information, etc. For example, the HMI display(s) 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 600 may include one or more systems on a chip (SoCs) 604 (described in more detail in FIG. 6D). The SoC(s) 604 may include CPU(s) 606, GPU(s) 608, processor(s) 610, cache(s) 612, accelerator(s) 614, data store(s) 616, and/or other components and features. The SoC(s) 604 may be used to process and provide data for various operations, such as navigation, planning, reasoning, inference, perception, control, and/or actuation operations of the machine 600 in a variety of platforms and systems. For example, the SoC(s) 604 may process live perception data (e.g., from camera, LiDAR, RADAR, ultrasonic, etc.) in addition to map data corresponding to one or more maps 622 (e.g., HD map, SD map, navigational map, occupancy map, etc.) in order to make or aid in performing various operations of the machine 600. Where a map and/or AI is used, map and/or AI (e.g., model parameter updates, fine-tuning, etc.) refreshes and/or updates via a network interface 624 from one or more servers (e.g., server(s) 678 of FIG. 6E)—such as one or more servers of a cloud-based data center.

Although an SoC(s) 604 is illustrated throughout FIGS. 6A-6E, additional or alternative components and/or architectures may be used-such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 600, use of the machine 600, model of the machine 600, and required capabilities of the machine 600, one or more SoCs 604 and/or alternative architectures and/or components may be used to satisfy the particular implementation.

The machine 600 may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The machine 600 may include a GPU(s) 620 (e.g., discrete GPU(s), or dGPU(s)), that may be coupled to the SoC(s) 604 via a high-speed interconnect (e.g., NVIDIA's NVLink). The GPU(s) 620 may provide additional artificial intelligence functionality, such as by executing redundant and/or different neural networks, and may be used to train and/or update neural networks based on input (e.g., sensor data) from sensors of the machine 600.

The machine 600 may further include the network interface 624 which may include one or more wireless antennas 626 and/or modems (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 600 information about vehicles in proximity to the machine 600 (e.g., vehicles in front of, on the side of, and/or behind the machine 600). This functionality may be part of a cooperative adaptive cruise control functionality of the machine 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 626 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 600 may further include data store(s) 628 which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The machine 600 may further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The machine 600 may further include IMU sensor(s) 666. The IMU sensor(s) 666 may be located at a center of the rear axle of the machine 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the machine 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include one or more microphone 696 placed in and/or around the machine 600. The microphone(s) 696 may be used for emergency vehicle detection and identification, among other things.

The machine 600 may further include vibration sensor(s) 642. The vibration sensor(s) 642 may measure vibrations of components of the machine, such as the arms or legs of a humanoid robot 600C, or the axle(s) of a vehicle 600A or AMR 600B. For example, changes in vibrations may indicate a change in road, walking, or traversable surfaces. In another example, when two or more vibration sensors 642 are used, the differences between the vibrations may be used to determine friction or slippage of the surface (e.g., when the difference in vibration is between a power-driven axle and a freely rotating axle).

The machine 600 may include an ADAS system 638—such as when the machine 600 is a vehicle 600A. The ADAS system 638 may include a dedicated SoC(s), in some examples. The ADAS system 638 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 600 may further include the infotainment SoC 630 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 600. For example, the infotainment SoC 630 may radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the machine 600. In some examples, the infotainment SoC 630 may be coupled to a supervisory MCU such that the GPU of the infotainment system may perform some self-driving functions in the event that the primary controller(s) 636 (e.g., the primary and/or backup computers of the machine 600) fail. In such an example, the infotainment SoC 630 may put the machine 600 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models-such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 600—whether a vehicle 600A, AMR 600B, humanoid robot 600C, and/or other type of machine—may include a locally stored language model(s) and/or communicate to a remotely hosted language model (e.g., via one or more APIs) to provide more detailed and in-depth communication features to the users of the machine(s) 600.

In some examples, an infotainment SoC 630, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 600. The always on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In some embodiments, an in-cabin monitoring camera sensor may be monitored using one or more neural networks running on another or dedicated SoC-such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 600.

The machine 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a block diagram of an example architecture of a computing system (a subset of the system described with respect to FIG. 6C), in accordance with at least some embodiments of the present disclosure. Although illustrated as an SoC(s) 604, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 604 may be an end-to-end platform with a flexible architecture that spans automation levels 2-5, or the SoC(s) 604 may be specifically designed for a specific automation level (e.g., a first SoC 604 for level 2 to level 2++, a second SoC 604 for level 3, a third SoC 604 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 2-5 autonomous vehicles as well as for safe planning, navigation, and control of AMRs 600B, humanoid robots 600C, and/or other robot or machine types.

In some embodiments, such as where the SoC(s) 604 include a GPU 608 with 2000 or more cores (e.g., 2048 cores), 60 or more tensor cores (e.g., 64 tensor cores), and a GPU max frequency of over 1 GHz (e.g., 1.3 GHZ), a CPU 606 including 10 or more cores (e.g., 12 cores), with 64 bits, 3 MB L2 and 6 MB L3 cache memory, and a max frequency of 2 or more GHz (e.g., 2.2 GHZ), one or more deep learning accelerators (DLAs), deep learning accelerator clusters (XNNs), neural network accelerators (NNAs), or neural processing units (NPUs) 609 (e.g., 2 DLAs/XNNs/NNAs/NPUs 609), and a vision accelerator-such as a programmable vision accelerator (PVA) 607, a single SoC 604) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 604 include a GPU 608 with 1700 or more cores (e.g., 1792 cores), 50 or more tensor cores (e.g., 56 tensor cores), and a GPU max frequency of over 900 MHz (e.g., 930 MHz), a CPU 606 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 609 (e.g., 2 DLAs/XNNs/NNAs/NPUs 609), and a vision accelerator-such as a programmable vision accelerator (PVA) 607, a single SoC 604) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 604 include a GPU 608 with 1000 or more cores (e.g., 1024 cores), 28 or more tensor cores (e.g., 32 tensor cores), and a GPU max frequency of over 900 MHz (e.g., 1173 MHz), a CPU 606 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 609 (e.g., 1 DLA/XNN/NNA/NPU 609), and a vision accelerator-such as a programmable vision accelerator (PVA) 607, a single SoC 604) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 604 include a GPU 608 with 1000 or more cores (e.g., 1024 cores), 28 or more tensor cores (e.g., 32 tensor cores), and a GPU max frequency of over 900 MHz (e.g., 1020 MHz), a CPU 606 including 6 or more cores (e.g., 6 cores), with 64 bits, 1.5 MB L2 and 4 MB L3 cache memory, and a max frequency of 1.5 or more GHz (e.g., 1.7 GHZ), a single SoC 604) may be capable of 67 tera operations per second (TOPS) of AI performance. For example, NVIDIA's Jetson Orin Nano 8 GB SoC satisfies these criteria, and achieves this performance.

The SoC(s) 604 may include one or more CPUs 606. The CPU(s) 606 may include a CPU cluster or CPU complex (alternatively referred to herein as a “CCPLEX”), in embodiments. The CPU(s) 606 may include multiple cores and/or (e.g., L2, L3) caches. For example, in some embodiments, the CPU(s) 606 may include twelve cores in a coherent multi-processor configuration. In some embodiments, the CPU(s) 606 may include four dual-core clusters where each cluster has a dedicated L2 cache (e.g., a 3 MB L2 cache). The CPU(s) 606 (e.g., the CCPLEX) may be configured to support simultaneous cluster operation enabling any combination of the clusters of the CPU(s) 606 to be active at any given time.

The SoC(s) 604 may include any type and number of GPUs 608. For example, an integrated GPU(s) (alternatively referred to herein as an “iGPU(s)”) may be used in some embodiments. The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive, robotics, and/or other embedded use cases. For example, the GPU(s) 608 may be fabricated on a Fin field-effect transistor (FinFET). However, this is not intended to be limiting and the GPU(s) 608 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

The SoC(s) 604 may include any number of cache(s) 612, including those described herein. For example, the cache(s) 612 may include L0 caches, L1 caches, L2 caches, L3 caches (e.g., that are available to both the CPU(s) 606 and the GPU(s) 608 (e.g., that is connected both the CPU(s) 606 and the GPU(s) 608)), etc. The cache(s) 612 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 604 may include one or more arithmetic logic units (ALUs) 665 which may be leveraged in performing processing with respect to any of the variety of tasks or operations of the machine 600—such as computer vision, machine learning or deep learning processing, world model management, etc. In addition, the SoC(s) 604 may include a floating point unit(s) (FPU(s)) 667—or other math coprocessor or numeric coprocessor types—for performing mathematical operations within the system. For example, the SoC(s) 104 may include one or more FPUs 667 integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory 615 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 614 (e.g., the hardware acceleration cluster) may include a deep learning accelerator(s) (DLA) 609 (alternatively referred to herein as “a deep learning accelerator cluster (XNN) 609,” “neural network accelerator (NNA) 609,” or “neural processing unit (NPU) 609”). The DLA(s) 609 may include one or more Tensor processing units (TPUs) 641 that may be configured to provide an additional, e.g., ten trillion operations per second for deep learning applications and inferencing. The TPUs 641 may be accelerators configured to, and optimized for, performing image processing functions (e.g., for CNNs, RCNNs, DNNs, etc.). The DLA(s) 609 may further be optimized for a specific set of neural network types and floating point operations, as well as inferencing. The design of the DLA(s) may provide more performance per millimeter than a general-purpose GPU, and vastly exceeds the performance of a CPU. The TPU(s) 641 may perform several functions, including a single-instance convolution function, supporting, for example, INT8, INT16, and FP16 data types for both features and weights, as well as post-processor functions. Although the TPU(s) 641 are described as being included as part of the DLA(s) 609, this is not intended to be limiting, and the TPU(s) 641 may be included in additional or alternative accelerator(s) 614 and/or other components, and/or may be included as a discrete processing component(s).

The DLA(s) 609 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 609 may perform any function of the GPU(s) 608, and by using an inference accelerator, for example, a designer may target either the DLA(s) 609 or the GPU(s) 608 for any function. For example, the designer may focus processing of DNNs and floating point operations on the DLA(s) 609 and leave other functions to the GPU(s) 608 and/or other accelerator(s) 614. The DLA(s) 609 may be used to run any type of network to enhance control and safety, including for example, a neural network that outputs a measure of confidence for each object detection.

The accelerator(s) 614 (e.g., the hardware acceleration cluster) may include a programmable vision accelerator(s) (PVA) 607, which may alternatively be referred to herein as a computer vision accelerator or generally a vision accelerator. The PVA(s) 607 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 607 may provide a balance between performance and flexibility. For example, each PVA(s) 607 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 607 may be optimized for the tasks of image processing and computer vision algorithm acceleration. For example, the PVA(s) 607 provides excellent performance with extremely low power consumption, and can be used asynchronously and concurrently with the CPU(s) 606, GPU(s) 608, and/or other accelerators in the system (e.g., vehicle, robot, etc.) as part of a heterogeneous compute pipeline.

The PVA(s) 607 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 643 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 606 (e.g., ARM Cortex-R5 processor), facilitating data exchange with the CPU(s) 606 and other system-level components. The VPU I-cache may supply instruction data to the VPU(s) when requested, may request missing instruction data from system memory, and/or may maintain temporary instruction storage for the VPU. For each VPU task, the CPU(s) 606 may configures the DMA system, optionally prefetch the VPU program into VPU I-cache, and/or kick off each VPU-DMA pair to process a task. The PVA(s) 607 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 607 to access the system memory independently of the CPU(s) 606. The DMA may support any number of features used to provide optimization to the PVA(s) 607 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 607 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 607, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 607 may be configured to employ data parallelism. For example, in some embodiments, the plurality of vector processors included in a single PVA(s) 607 may execute the same computer vision algorithm, but on different regions of an image. In other examples, the vector processors included in a particular PVA(s) 607 may simultaneously execute different computer vision algorithms, on the same image, or even execute different algorithms on sequential images or portions of an image. Among other things, any number of PVAs 607 may be included in the hardware acceleration cluster and any number of vector processors may be included in each of the PVAs. In addition, the PVA(s) 607 may include additional error correcting code (ECC) memory, to enhance overall system safety.

The accelerator(s) 614 (e.g., the hardware accelerator cluster) have a wide array of uses for autonomous and semi-autonomous machine control. The PVA(s) 607 may be a programmable vision accelerator that may be used for key processing stages in perception, robotics understanding and reasoning, ADAS, semi-autonomous, and autonomous vehicles, etc. The PVA's 607 capabilities are a good match for algorithmic domains needing predictable processing, at low power and low latency. In other words, the PVA(s) 607 performs well on semi-dense or dense regular computation, even on small data sets, which need predictable run-times with low latency and low power. Thus, in the context of platforms for autonomous vehicles and robotics, the PVAs 607 are designed to run classic computer vision algorithms, as they are efficient at object detection and operating on integer math.

For example, according to one embodiment of the technology, the PVA 607 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 607 may perform computer stereo vision function on inputs from two monocular cameras.

In some examples, the PVA(s) 607 may be used to perform dense optical flow. According to process raw RADAR data (e.g., using a 4D Fast Fourier Transform) to provide Processed RADAR. In other examples, the PVA(s) 607 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 607, this is not intended to be limiting. In some embodiments, these components may be included in alternative or additional processing components and/or accelerator(s) 614, and/or may be included as discrete components of the SoC(s) 604 and/or other computing system architecture(s).

In some examples, the SoC(s) 604 may include a real-time ray-tracing hardware accelerator (RTA) 651 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 600 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 651 and/or a ray-tracing optimized GPU 606—such as NVIDIA's RTX GPU.

The accelerator(s) 614 (e.g., in the hardware acceleration cluster) may include one or more optical flow accelerators (OFAs) 611. For example, the OFA(s) 611 may be used for computing optical flow and stereo disparity between frames of sensor data (e.g., images). Optical flow may be accelerated on the OFA(s) 611 for uses such as object detection and tracking, and/or for stereo depth estimation where used for computing stereo disparity between stereo image frames (e.g., two or more frames captured using two or more image sensors with at least partially overlapping fields of view).

The SoC(s) 604 may include one or more camera serial interfaces (CSIs) 623. For example, the CSI(s) 623 may include a mobile industry processor interface (MIPI) camera serial interface (CSI) for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role. For example, the CSI 623 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and implementation.

The accelerator(s) 614 (e.g., the hardware acceleration cluster) may include a computer vision network on-chip (CVNOC) 663 and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by the PVA 607, OFA 611, DLA 609, and/or other accelerator(s) 614. Each pair of memory blocks may include an advanced peripheral bus (APB) interface, configuration circuitry, a controller, and a multiplexer. Any type of memory 615 may be used. The PVA 607, OFA 611, DLA 609, and/or other accelerator(s) 614 may access the memory via a backbone that provides the accelerator(s) 614 with high-speed access to memory. The backbone may include a computer vision network on-chip that interconnects the accelerator(s) 614 to the memory (e.g., using the APB).

The CVNOC 663 may include an interface that determines, before transmission of any control signal/address/data, that the accelerator(s) 614 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 604 may include data store(s) 616 and/or memory 615. The data store(s) 616 may be on-chip memory 615 of the SoC(s) 604, which may store neural networks and/or other algorithms to be executed on the CPU(s) 606, the GPU(s) 608, and/or one or more of the accelerator(s) 614. In some examples, the data store(s) 616 may be large enough in capacity to store multiple instances of neural networks for redundancy and safety. The data store(s) 612 may comprise L2 and/or L3 cache(s) 612, for example. The memory(ies) 615 may include SRAM, LPDDR5, and/or other memory types. For example, the memory(ies) 615 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 616 may include reference to the memory associated with the PVA 607, OFA 611, DLA 609, and/or other accelerator(s) 614, as described herein.

The data store(s) 116 may include various storage types, such as eMMC, NVMe, etc. For example, the SoC(s) 604 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 616 and/or other storage may be accessed via, e.g., NVMe, using PCI Express (PCIe), RDMA, TCP, and/or other protocols.

The SoC(s) 604 may include one or more processor(s) 610 (e.g., embedded processors). The processor(s) 610 may include a boot and power management processor (BPMP) 653, that may be a dedicated processor and subsystem to handle boot power and management functions and related security enforcement. The BPMP 653 may be a part of the SoC(s) 604 boot sequence and may provide runtime power management services. The BPMP 653 may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, accelerator(s) 614, and/or other components. If temperatures are determined to exceed a threshold, BPMP 653 may enter a temperature fault routine and put the SoC(s) 604 into a lower power state and/or put the machine 600 into a chauffeur to safe stop mode (e.g., bring the machine 600 to a safe stop).

The processor(s) 610 may further include a set of embedded processors that may serve as an audio processing engine (APE) 655. The APE 655 may be an audio subsystem that enables full hardware support for multi-channel audio over multiple interfaces, and a broad and flexible range of audio I/O interfaces. In some examples, the APE 655 is a dedicated processor core with a digital signal processor with dedicated RAM.

The processor(s) 610 may further include an always on processor engine (AOPE) 657 that may provide necessary hardware features to support low power sensor management and wake use cases. The AOPE 657 may include a processor core, a tightly coupled RAM, supporting peripherals (e.g., timers and interrupt controllers), various I/O controller peripherals, and routing logic.

The processor(s) 610 may further include a safety processor(s) 613 (alternatively referred to as “safety island 613”), which may include a safety cluster engine that includes a dedicated processor or processor subsystem to handle safety management for automotive, robotics, and/or other applications. The safety processor(s) 613—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 613 may include a discrete processor(s), such that fault of other system components may not impact the performance and availability of the safety processor 613.

The processor(s) 610 may further include a real-time or near real-time sensor engine (SE) 659 that may include a dedicated processor subsystem for handling real-time or near real-time camera, LiDAR, RADAR, and/or other sensor modality management.

The processor(s) 610 may further include one or more image signal processors (ISPs) 627, which may include a high-dynamic range signal processor and/or a hardware engine that is part of one or more sensor processing pipelines.

The processor(s) 610 may include a video image compositor (VIC) 661 that may be a processing block (e.g., implemented on a microprocessor) that implements video post-processing functions needed by a video playback application to produce the final image for the player window. The VIC 661 may perform lens distortion correction on wide-view camera(s) 668B, surround camera(s) 668D, in-cabin monitoring camera sensors, and/or other camera sensors with distorted fields of view.

A VIC 661 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 661 may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a broad range of peripheral interfaces for input/output (I/O) 625, such as to enable communication with peripherals, audio codecs, power management, and/or other devices. The SoC(s) 604 may be used to process data from cameras (e.g., connected over Gigabit Multimedia Serial Link and/or Ethernet), sensors (e.g., LiDAR sensor(s) 664, RADAR sensor(s) 660, etc. that may be connected over Ethernet), data from bus 602 (e.g., speed of machine 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks. In some embodiments, the SoC(s) 604 I/O 625 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 625 elements, components, or features.

The SoC(s) 604 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 604 may include an RJ45 connector with up to 10 GbE, a 1 GbE connector, and/or other networking connector types.

The SoC(s) 104 may include one or more digital signal processors (DSPs) 643. For example, the DSP(s) 643 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 604 may include one or more video encoders 619 and/or one or more video decoders 621. For example, the video encoder(s) 619 may include a hardware-based (e.g., as part of the GPU(s) 608) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 621 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 621 may be hardware-based (e.g., as part of the GPU(s) 608).

The SoC(s) 604 may include one or more general compute acceleration clusters (GCAC(s)) 629. For example, the GCAC(s) 629 may include various processor types that may be used to accelerate compute, such as one or more vector microcode processors (VMPs) 633, one or more multi-threaded processing clusters (MPCs) 631, one or more programmable macro arrays (PMA(s)) 635, and/or one or more other processor types. For example, the GCAC(s) 629 may include a PMA 635, two VMPs 633, and 2 MPCs 631.

The SoC(s) 604 may include one or more vector microcode processors (VMPs) 633. The VMP(s) 633, in embodiments, may include a wide vector (very long instruction word (VLIW) and single instruction multiple data (SIMD)) machine with performing various operations, such as short integral type operations common in computer vision and deep learning algorithms.

The SoC(s) 604 may include one or more multi-threaded processing clusters (MPCs) 631. The MPC(s) 631 may include a processing cluster that be, in embodiments, more versatile than a GPU, and with higher efficiency than a CPU. For example, the MPC(s) 631 may include a multi-threaded processor that allows multiple threads to share resources and execute instructions concurrently.

The SoC(s) 604 may include one or more programmable macro arrays (PMA(s)) 635. The PMA(s) 635 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 604 may include one or more display processing units (DPUs) 645 for performing hardware-accelerated image processing. For example, the DPU(s) 645 may retrieve pixel data from memory 615 and send it to a display peripheral through standard interfaces. As such, the DPU(s) 645 may handle display processing and rendering for in-machine and/or on-machine displays.

The SoC(s) 604 may include one or more application processing units (APUs) 639. For example, the APU(s) 639 may include a quad or dual-core processor with 48 KB/32 KB L1 cache with parity and ECC, along with a 1 MB L2 cache with ECC. The APU(s) 639 may support NEON instructions and single and double precision floating point operations.

The SoC(s) 604 may include one or more real-time processing units (RTPUs) 669. The RTPU(s) 669 may include a dual-core processor with 32 KB/32 KB L1 cache, and 256 KB TCM with ECC. The RTPU(s) 669 may support single and double precision floating point operations.

The SoC(s) 604 may include one or more built-in self-test (BIST) components 637. For example, the BIST component(s) 637 may include memory BIST (MBIST) to test memories of the system and/or logic BIST (LBIST) to test logic of the system. The BIST components 637 may include embedded logic for directly testing logic and/or memory of the system.

The SoC(s) 604 may include one or more dynamically reconfigurable processors (DRPs) 671. For example, the DRP(s) 671 may be used for accelerating various computing operations. For example, the DRP(s) 671 may be combined, in embodiments, with a MAC unit for use as an AI accelerator. In embodiments, the DRP(s) 671 may execute applications while dynamically switching the circuit connection configuration of the arithmetic units (e.g., ALUs) on the chip at each operating clock according to the content to be processed. Since only the necessary arithmetic circuits are used, the DRP(s) 671 may consume less power than with CPU processing and can achieve higher speed. Furthermore, compared to CPUs, where frequent external memory accesses due to cache misses and other causes will degrade performance, the DRP(s) 671 can build the necessary data paths in hardware ahead of time, resulting in less performance degradation and less variation in operating speed (jitter) due to memory accesses. The DRP(s) 671 may include a dynamic loading function that switches the circuit connection information each time the algorithm changes, enabling processing with limited hardware resources, even in robotic/automotive applications that require processing of multiple algorithms.

In some embodiments, the accelerator(s) 614 may include an OpenCV accelerator for speeding up processing of OpenCV, an open-source industry standard library for computer vision processing. In some embodiments, the combination of one or more DRP(s) 671 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 604 may include various compute engines (e.g., processors 610, CPUs 606, GPU(s) 608, accelerator(s) 614, etc.), tasks may be distributed between and among the compute engines, in some instances without common cause failures due to the discrete footprint of the compute engines. Further, because the SoC(s) 604 may include a dedicated safety processor(s) 613 (or safety island 613), critical safety or redundant operations may be performed without common cause failures from the main processing components or compute engines of the SoC(s) 614. Due to these features, the SoC(s) 604 and/or the underlying systems of the machine 600 may be capable of satisfying higher levels of safety-such as automotive safety integrity level (ASIL) D from the ISO 26262 standard.

FIG. 6E is a system diagram for communication between a cloud-based server(s) (e.g., in a data center, such as those described herein) and the example autonomous or semi-autonomous vehicle or machine 600 of FIG. 6A, in accordance with some embodiments of the present disclosure. The system 676 may include a server(s) 678, a network(s) 690, and a machine(s) 600. The server(s) 678 may include a plurality of GPUs 684(A)-684(H) (collectively referred to herein as GPUs 684), switches 682(A)-682(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 680(A)-680(B) (collectively referred to herein as CPUs 680), accelerators, and/or other processor types. The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the machine(s) 600, sensor data indicating information about new or previously unexplored locations, and/or sensor data indicating changes to previously seen/stored locations (e.g., unexpected or changed road conditions, such as recently commenced road-work). The server(s) 678 may transmit, over the network(s) 690 and to the machine(s) 600, neural networks 692, updated neural networks 692, map information 694, etc., including information regarding traffic and road conditions. The updates to the map information 694 may include updates for the HD map 622, SD map, navigation map, etc., such as information regarding construction sites, potholes, detours, flooding, and/or other obstructions. In some examples, the neural networks 692, the updated neural networks 692, the map information 694, and/or the other information may have resulted from new training and/or experiences represented in data received from any number of machine(s) 600 in the environment, and/or based on training performed at a datacenter (e.g., using the server(s) 678 and/or other servers).

The server(s) 678 may be used to train machine learning models (e.g., neural networks) based on training data. The training data may be generated by the machine(s) 600, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 600 (e.g., transmitted to the machine(s) 600 over the network(s) 690, and/or the machine learning models may be used by the server(s) 678 to remotely monitor and/or control the machine(s) 600.

In some examples, the server(s) 678 may receive data from the machine(s) 600 and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the machine 600. For example, the deep-learning infrastructure may receive periodic updates from the machine 600, such as a sequence of images and/or objects that the machine 600 has located in that sequence of images (e.g., via computer vision and/or other machine learning object classification techniques). The deep-learning infrastructure may run its own neural network to identify the objects and compare them with the objects identified by the machine 600 and, if the results do not match and the infrastructure concludes that the AI in the machine 600 is malfunctioning, the server(s) 678 may transmit a signal to the machine 600 instructing a fail-safe computer of the machine 600 to assume control, notify the passengers, and complete a safety maneuver or operation-such as to slow down, hand control back to a driver, come to a stop, and/or pull over/shut down.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE CLAUSES

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A wire, comprising:
a plurality of circular arcs, wherein:
each of the circular arcs comprises a quadrantal arc; and
each of the circular arcs has a radius determined at least partially using a coherence length of an optical wavelength of a light emitted by a light source, wherein the light is interacting with the circular arcs.

2. The wire of claim 1, wherein the radius of each of the circular arcs is equal to or greater than 10 times the coherence length.

3. The wire of claim 1, wherein each of the circular arcs has a same radius, and the circular arcs have a same shape.

4. The wire of claim 1, wherein the circular arcs comprise a first circular arc and a second circular arc, the second circular arc extending from a first end of the first circular arc.

5. The wire of claim 4, wherein the circular arcs comprise a third circular arc, the first circular arc and the second circular arc facing a first direction and the third circular arc facing a second direction opposite the first direction.

6. An imaging system, comprising a camera, wherein the wire of claim 1 is located in a field of view of the camera.

7. The imaging system of claim 6, wherein the wire is a plurality of wires, the plurality of wires located in the field of view of the camera.

8. The imaging system of claim 6, further comprising a transparent medium in the field of view of the camera, wherein the wire is embedded in the transparent medium.

9. A machine, comprising:
at least one window;
an imaging system; and
the wire of claim 1, wherein:
the machine provides the wire with an electrical current;
the at least one window is at least partially in a field of view of the imaging system; and
the wire is embedded in the at least one window.

10. The vehicle of claim 9, wherein the wire is a plurality of wires and the at least one window is a windshield, the imaging system located within the machine and facing the windshield, the plurality of wires embedded in the windshield in the field of view of the imaging system.

11. A wire, comprising:
a plurality of circular portions comprising at least a first circular portion and a second circular portion, wherein:
the second circular portion extends from a first end of the first circular portion;
the first circular portion faces a first direction and the second circular portion faces a second direction opposite the first direction; and
the plurality of circular portions have a radius determined at least partially using a coherence length of an optical wavelength of a light emitted by a light source, wherein the light is interacting with the circular portions.

12. The wire of claim 11, wherein each of the circular portions have a same radius, and the circular portions have a same shape.

13. The wire of claim 11, wherein the first circular portion and the second circular portion are semicircular arcs.

14. The wire of claim 11, wherein the radius of each of the circular portions is equal to or greater than 10 times the coherence length.

15. A machine, comprising:
at least one window;
at least one camera; and
the wire of claim 11, wherein:
the machine provides the wire with an electrical current;
the at least one window is at least partially in a field of view of the at least one camera; and
the wire is embedded in the at least one window.

16. The vehicle of claim 15, further comprising a camera housing in contact with a portion of the at least one window, the at least one camera located in the camera housing, the plurality of wires embedded in the portion of the at least one window.

17. A wire, comprising:
a plurality of circular portions, wherein each of the circular portions has a radius determined at least partially using a coherence length of an optical wavelength of a light emitted by a light source, wherein the light is interacting with the circular portions.

18. The wire of claim 17, wherein the plurality of circular portions oscillate above and below a center axis.

19. The wire of claim 17, wherein the radius of each of the circular portions is equal to or greater than 10 times the coherence length.

20. An imaging system, comprising at least one camera and a transparent medium in a field of view of the at least one camera, the wire of claim 17 embedded in the transparent medium.
